(19) United States
(12) Patent Application Publication
(10) Pub. No.: US 2020/0304448 A1
(43) Pub. Date: Sep. 24, 2020

(54) System and Method for Detecting and Predicting Level of Importance of Electronic Mail Messages

(71) Applicant: Robert Bosch GmbH, Stuttgart (DE)

(72) Inventors: Fan Zhang, Pittsburgh, PA (US); Lin Zhao, Sunnyvale, CA (US); Kui Xu, Sunnyvale, CA (US)

(21) Appl. No.: 15/779,592

(22) PCT Filed: Dec. 1, 2016
(86) PCT No.: PCT/EP2016/079447

§ 371 Date: May 29, 2018

Related U.S. Application Data
(60) Provisional application No. 62/261,530, filed on Dec. 1, 2015.

(51) Int. Cl. H04L 12/58; G06F 40/279; G06F 40/258

(52) U.S. Cl. CPC H04L 51/26; G06F 40/258; G06F 40/279

(57) ABSTRACT

A non-transitory machine accessible medium includes a topic detection module for extracting major topics from an electronic mail message, a sender role and receiver role detection module for detecting role information of one of the sender and the receiver from the electronic mail message, and a relationship detection module for comparing a relationship between the extracted topic information and the role information. The detection modules can be based on statistical or rule-based approaches. Based on the detected information, the non-transitory machine accessible medium predicts a level of importance of the electronic mail message based on a machine learning algorithm.

### FIELD

The patent relates generally to electronic mail messages and, more particularly, to detecting content information from an electronic mail message and predicting its level of importance.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure related to systems and methods for detecting and predicting level of importance of Electronic Mail Message. For example, a method comprises detecting topic information from an electronic mail message using topic detection module, detecting role information of one of the sender and the receiver from the electronic mail message using a role detection module, detecting a relationship between the topic information and the role information using a relationship detection module, and predicting level of importance based of the detected topic, role and relationship information. The embodiment further includes at least one of N-grams, Part-of-Speech (POS) Tags, Length features, Content features, meta features and the like located in one or more of a topic detection, a sender and receiver role detection, and relationship detection. Each detection includes in a non-transitory machine accessible medium when accessed by a machine, cause the machine to perform operations.

In alternate embodiment, a non-transitory machine accessible medium comprises a first detection module for detecting topic information from an electronic mail message, a second detection module for detecting role information of one of the sender and the receiver from the electronic mail message, a third detection module for detecting a relationship between the detected topic information and the detected role information. Based on the detected topic, role and relationship information the non-transitory machine accessible medium predicts level of importance of the electronic mail message. The feature includes at least one of N-grams, Part-of-Speech (POS) Tags, Length features, Content features, meta features and the like. Such feature is located in one or more of the detection modules.

The first detection module is a topic detection module, the second detection module is a sender role and receiver role detection module, the third detection module is a relationship detection module.

### BRIEF DESCRIPTION OF THE DRAWINGS

These and other features, aspects, and advantages of this disclosure will become better understood when the following detailed description of certain exemplary embodiments is read with reference to the accompanying drawings in which like characters represent like arts throughout the drawings, wherein:

FIG. 1 is an example of an electronic mail message in accordance with a described embodiment of a disclosure;

FIG. 2 is a block diagram of a network computing system, in accordance with a described embodiment of the disclosure;

FIG. 3 is a block diagram of a client machine, in accordance with the described embodiment of the disclosure; and

FIG. 4 is a block diagram of a manager system module, in accordance with a described embodiment of the disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such development effort might be complex and time consuming, but would nevertheless be a routine undertaking of design, fabrication, and manufacture for those of ordinary skill having the benefit of this disclosure.

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

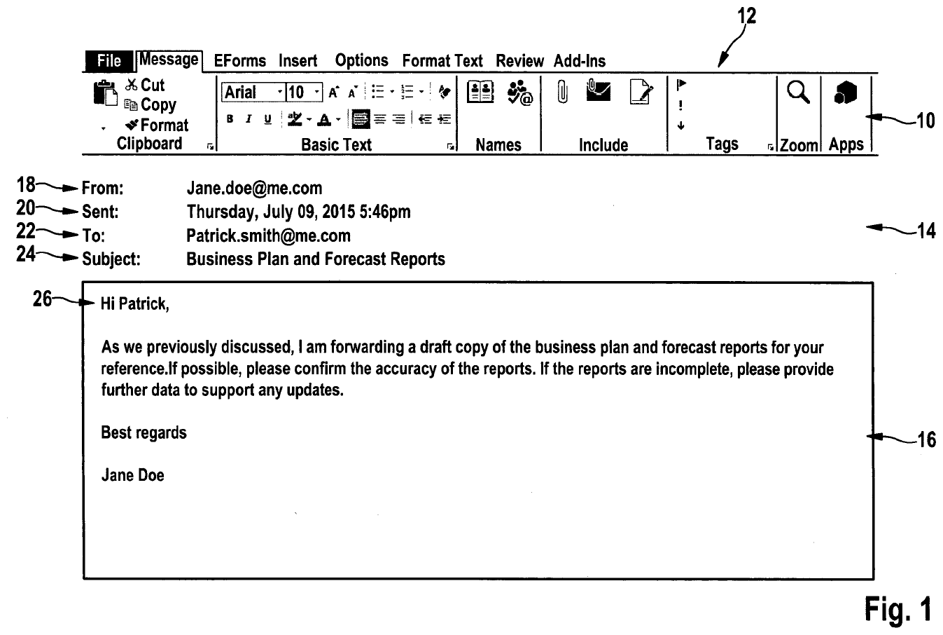

FIG. 1 depicts an example of an electronic mail message 10 which includes a tool bar section 12 and context sections 14, 16. The electronic mail message 10 includes e-mails, test messages (SMS), and other electronic documents which include references to the sender and the receiver. The tool bar section 12 lets the user know that several features or functions are available for operation. The first context section or a header 14 includes information such as sender profile 18, recipient profile 22, stamped date 20, and subject information 24. Optionally, an attachment information may be included in this section 14 or elsewhere in the email 10. Other information such as a thumbnail icon, an avatar, and the like may be included in the context section 14 or elsewhere in the email 10. In one embodiment, more than one recipient profile can be included in the email 10. In alternate embodiment, one or more recipients profile previously omitted or not depicted in the email may be later included in the exchanged email. In yet another embodiment, one or more recipients profile previously listed in the email may be removed or modified before the email is forwarded to another or different recipient. Similarly, the sender profile 18 in the later sent email may be different from the sender profile in the original email where the sender profile is removed or replaced. The subject information 24 in the first context section 14 can contain the same information in the later sent email as in the original sent email or different information in the later sent email compared with the previous/original sent email modified by one of the sender or the recipient. The subject information 24 can also appear elsewhere in the email 10 such as in the second context section 16 and not necessary is included or attached in the context section 14. In another example, the email 10 can include more than one subject information in one or more locations 14, 16. Partial or all the subject information 24 appears in various locations 14, 16 does not necessary be the same. The second context section 16 includes an object profile 26. The object profile 26 may include at least one of the information such as text, image, video, audio, chart, figure, graph, symbol, icon, link, or the like. The object profile may be in different forms of font, color, size, configuration, or the like. In one embodiment, a clause or disclaimer (not shown) may be automatically attached in the email and can be located either before, within, after the object information in the second context section 16. Similarly, the object profile 26 can include at least a portion of the subject information 24. As illustrated, the object profile is in text format.

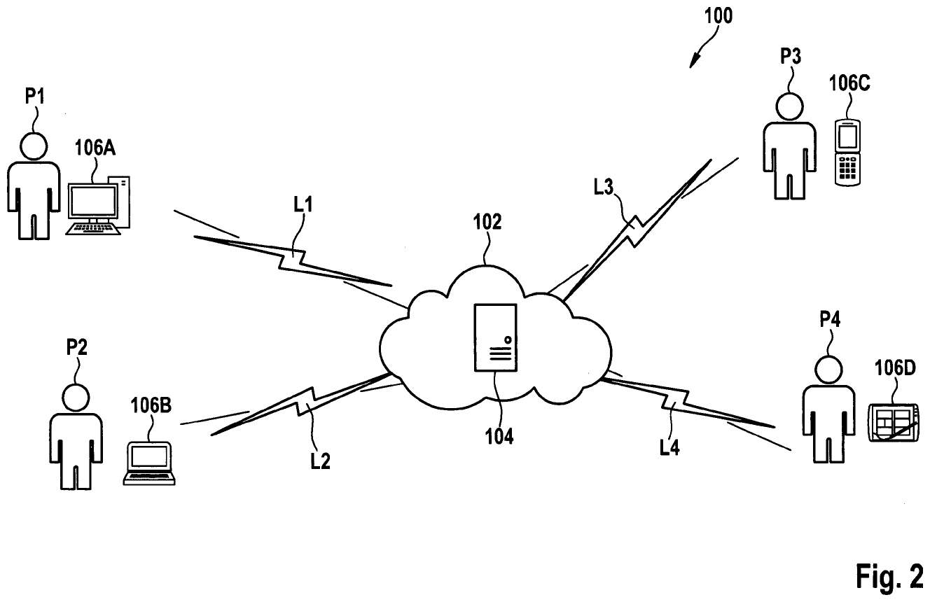

FIG. 2 illustrates a block diagram of a network computing system 100 according to an exemplary embodiment of a disclosure. The system 100 includes a network 102 communicatively coupled one or more users, four users P1-P4 are illustrated, via at least one communication link, four links L1-L4 are illustrated, in a distributed computing environment. Each user P1-P4 interacts with at least one client machine (electronic device or information/computer processing system) 106A-106D where tasks are performed by the one or more client machines 106A-106D that are linked through one or more servers 104 over the network 102. The client machine may be a personal computer or desktop computer 106A, a laptop 106B, a cellular or smart phone 106C, a tablet 106D, a personal digital assistant (PDA), a gaming console, an audio device, a video device, an entertainment device such as a television, a vehicle infotainment, or the like. The users P1-P4 can provide input to the client machines 106A-106D through a number of ways which may be for example by voice input (saying a sentence), video input (recording a video), typing, touching a screen, and the like. The server 104 may be an application server, a certificate server, a mobile information server, an e-commerce server, a FTP server, a directory server, CMS server, a printer server, a management server, a mail server, a public/private access server, a real-time communication server, a database server, a proxy server, a streaming media server, or the like. The client machine 106A-106D can in some embodiment be referred to as a single client machine or a single group of client machines, while the server 104 may be referred to as a. single server or a single group of servers. In one embodiment a single client machine communicates with more than one server, while in another embodiment a single server communicates with more than one client machine. In yet another embodiment, a single client machine communicates with a single server 106.

The network 102 can comprise one or more sub-networks, and can be installed between any combination of the client machines 106A-106D, the server 104, computing machines and appliances included within the network computing system 100. In some embodiments, the network 102 can be for example a local-area network (LAN), a metropolitan area network (MAN), a wide area network (WAN), a primary network 104 comprised of multiple sub-networks located between the client machines 106A-106D and the server 104, a primary public network with a private sub-network, a primary private network with a public sub-network, or a primary private network with a private sub-network 104. Still further embodiments include a network 102 that can be any network types such as a point to point network, a broadcast network, a telecommunication network, a data communication network, a computer network, an ATM (Asynchronous Transfer Mode) network, a SONET (Synchronous Optical Network) network, a SDH (Synchronous Digital Hierarchy) network, a wireless network, a wireline network, and the like. Depending on the application, other networks may be used so that data exchanged between the client machine and the server can be transmitted over the network. Network topology of the network 102 can differ within different embodiments which may include a. bus network topology, a star network topology, a ring network topology, a repeater-based network topology, or a tiered-star network topology. Additional embodiments may include a network of mobile telephone networks that use a protocol to communicate among mobile devices, where the protocol can be for example AMPS, TDMA, CDMA, GSM, GPRS, UMTS, LTE or any other protocol able to transmit data among mobile devices.

The communication link L1-L4 may be wired, wireless, or combination thereof. The system 100 may be used in commonplace in offices, enterprise-wide computer networks, intranets, internets, public computer networks, or combination thereof. The wireless communication link may include cellular protocol, data packet protocol, radio frequency protocol, satellite band, infrared channel, or any other protocol able to transmit data among client machines. The wired communication link may include any wired line link.

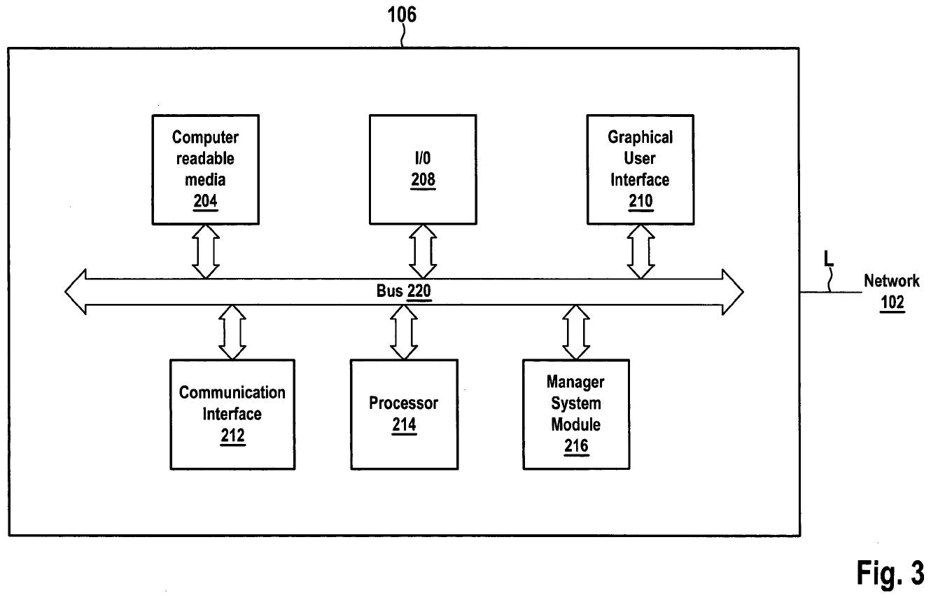

FIG. 3 is a block diagram of a client machine 106 according to exemplary embodiment of the disclosure. The client machine 106 is communicatively coupled to a network 102 via a communication link L. The client machine 106 may be any type of electronic device or information processing system. For example, the electronic device may be a personal computer, a desktop computer, a server computer, a client computer, a laptop, a cellular or smart phone, a tablet, a personal digital assistant, a gaming console, an audio device, a video device, an entertainment device such as a television, a vehicle infotainment, or the like. The client machine 106 includes a computer readable media 204, an input/output subsystem 208, a graphical user interface 210, a communication interface 212, a computer processor unit (CPU) or multiprocessor 214, a manager system module 216, and other computer implemented devices. One or more system buses 220 communicatively coupled to one or more computer implemented devices. The system buses 220 may be any types of bus structures including a memory or a memory controller, a peripheral bus, a local bus, and any type of bus architectures. The computer implemented devices incorporated in the client machine 106 may include video adapter, digitizer, printer, gesture recognition module, speaker, microphone, camera, and the like.

The computer readable media 204 may be partitioned or otherwise mapped to reflect the boundaries of the various subcomponents. The computer readable 204 typically includes both volatile and non-volatile media, removable and non-removable media. For example, the computer readable media 204 includes computer storage media and communication media. Computer storage media includes both volatile and nonvolatile, removable and non-removable media implemented in any method or technology, CD-ROM, DVD, optical disk storage, magnetic cassettes, magnetic tape, magnetic disk storage or other magnetic storage device, or any other medium which can be used to store the desired information and which can accessed by a client machine. For example, computer storage media can include a combination of random access memory (RAM), read only memory (ROM) such as BIOS. Communication media typically includes computer readable instructions, data structures, program modules, or other data in a modulated data signal such a carrier wave or other transport mechanism and include any information delivery media. Communication media may also include wired media such as a wired network or direct-wired communication, and wireless media such as acoustic, RF, infrared (IR) and other wireless media. Communications of the any of the above should also be included with the scope of computer readable media.

The input/output subsystem 208 includes various end user interfaces such as a display, a keyboard, joystick, a mouse, a trackball, a touch pad, a touch screen or tablet input, a foot control, a servo control, a game pad input, an infrared or laser pointer, a camera-based gestured input, and the like capable of controlling different aspects of the machine operation. For example, user can input information by typing, touching a screen, saying a sentence, recording a video, or other similar inputs. The communication interface 212 allows software and data to be transferred between the computer system and other external electronic devices in the form of signals which may be, for example, electronic, electromagnetic, optical, or other signals capable of being received by the communication interface 212. The communication interface 212 may be for example a modem, a network interface, a communication port, a PCM-CIA slot and card, or the like.

The processor 214 may be a general or special purpose microprocessor operating under control of computer executable instructions, such as program modules, being executed by a client machine. Program modules generally include routines, programs, objects, components, data structure and the like that perform particular tasks or implement particular abstract types. In one embodiment, some or all of the sub-processors may be implemented as computer software tangibly stored in a memory to perform their respective functions when executed. In alternate embodiment, some or all of the sub-processors may be implemented in an ASIC.

The manager system module 216 can be a single module and coupled to other computer implemented device via the system bus. The manager system module 216 can also be integrated into at least one of the computer readable media 204, the processor 214, or any computer implemented device. The manager system module 216 includes instructions for detecting object information and content information in at least one electronic mail message, detecting the relationship between the detected object information and detected content information, and predicting level of importance of the electronic mail message based on the detected object information, detected content information, and detected relationship. In one embodiment, the manager system module 216 may be integrated into the server 104 for detecting object information and content information in at least one electronic mail message, detecting the relationship between the object information and content information, and predicting level of importance of the electronic mail message. In alternate embodiment, more than one manager system module 216 may be coupled or integrated into the client machine 106, the server 104, and any computer implemented device. The detection and prediction of the object information, content information, the relationship, and level of importance may be either performed by a single manager system module or several manager system. The object information may be a topic information and the content information may be the roles of the sender and the receiver. A topic modeling in a form of computer executable instructions stored in the manager system model 216 is used to detect the topic information.

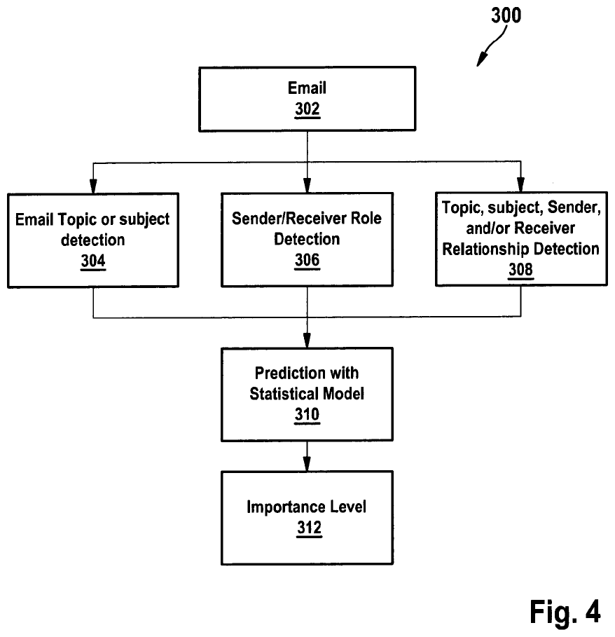

FIG. 4 is a block diagram of a manager system module 300 according to an exemplary embodiment of the disclosure. One or more emails 302 can be retrieved from, for example, a mail server 104 over a network 102 as depicted in FIG. 2. In one embodiment, one or more of instructions such as detecting at least one of the object information and content information in an electronic mail message, detecting the relationship between at least one of the object information and content information, and predicting level of importance of the electronic mail message may be performed by the mail server 104. In another embodiment, one or more of instructions such as detecting at least one of the object information and content information in an electronic mail message, detecting the relationship between at least one of the object information and content information, and predicting level of importance of the electronic mail message may be performed by a subsystem outside the mail server 104. The subsystem may be a manager system module 216, a processor 214, or any computer implemented device of a client machine 106A-106D. The object information and content information includes topic information, sender information, receiver information, roles of the sender and the receiver, relationships between topic information, sender information receiver information, and roles.

At least one of topic detection 304, role detection 306, and relationship detection 308 of one or more incoming emails can be performed by any server, manager system module, processor, computer implemented device, and the like. The topic detection 304 includes detecting of topic information in at least one of the first and second context section 14, 16 and anywhere else in the email using a topic modeling. In some embodiment, the topic modeling may be in a form of computer executable instructions stored in the topic detection 304 configured to detect the topic information. The detected topics can be a list of keywords extracted or derived from the content of the email. The topic information may be categorized/structured into one or more groups/community such as business contact group, personal contact group, social contact group, advertisement contact group, and the like. The personal contact group may be further categorized/structured into several sub-groups such as family and friends. Similarly, the business contact group may also be categorized/structured into several sub-groups such as internal business/co-workers and external business liaisons. Various levels or hierarchy can be assigned to one of the groups or sub-groups, depending on the application. For example, family sub-group of the personal contact group can be divided into levels or hierarchy distant family, direct family, and the like. Other topic information includes as junk, span, or the like may be discarded or removed without assigning a specific group.

Roles or title of the sender and the receiver in at least one of the first context section 14, second context section 16, and elsewhere in the email can be performed by the role detection 306. The role of the title of one of the sender and receiver may include such as business title or job function, family role, social role, in various environments. In one embodiment, the role or title of one of the sender and receiver may not be visibly available in the first context section 14, the role detection 306 continue to detect information in either the second context section 16 or the elsewhere in the email. In this case, the information can be title or role of the sender/receiver appeared in a signature field or among the content of information in text format or other format. In another embodiment, the role or title of one of the sender and receiver may be outside the business context such as personal (friend, family), social, community, and the like.

The relationship between at least one of the object information, content information, topic information, sender, receiver in the email can be identified and detected using the relationship detection 308. The relationship may be close-close relationship, close-distant relationship, distant-distant relationship, direct-indirect relationship, and the like. The relationship can be further categorized into various content-role, environment-role, and content-environment relationships. For example, the relationship includes employer-to-employee relationship, peer-to-peer relationship, husband-wife relationship, parent-child relationship, client-business relationship, friend-friend relationship, and the like. In one embodiment, one or more of the detections 304, 306, 308 may be performed either in a single step or multiple steps using a single computer implemented device or various computer implemented devices. In another embodiment, some or all the detections 304, 306, 308 may be performed simultaneously in a single step.

Each detections 304, 306, 308 include at least one feature extractor. The feature extractor includes N-grams, Part-of-Speech (POS) Tags, Length features, Content features, and the like, suitable for detecting at least one of the topic information, object information, or content information in at least one electronic mail message, identifying the role of the sender and receiver, detecting the relationship between the at least one of the topic information, object information, content information, or roles of the sender and receiver, and predicting level of importance of the electronic mail message. For example, POS tags analyze input word's characteristics based on word, context and the like. Any known POS techniques available in the field may be used to analyze input word's characteristics. Length features analyze information such as length of content, number of word counts, and the like. In one embodiment, POS tags and Length features are two independent feature extractor for performing different analysis. In another embodiment, POS tags and Length features can be integral into a single feature extractor for performing some or all the analysis. Content feature extract hints of the email message content such as number of question marks, data information, capitalized words, and the like.

A statistical model 310 in the form of software or firmware are provided in the manager system module for detecting topics in an electronic mail message, identifying the role of the sender and receiver, detecting the relationship between the at least one of the topic information, or roles of the sender and receiver, and predicting level of importance of the electronic mail. The model for detecting the topics, roles or relations can be statistical or rule-based. As illustrated in FIG. 4, the information detected by the modules 304, 306, 308 are transmitted or sent to the statistical module 310 for predicting level of importance of one or more electronic mail messages. In some embodiment, more than one statistical model may be provided to perform different functions. In one embodiment, the statistical model for predicting the importance level may be Support Vector Machine (SVM). Other machine learning algorithms known in the field may be used. The model uses all the detected information as input features to predict level of importance of the electronic mail message. Once the level of important is determined at block 312, the information is transmitted to the client machine for display as human readable format.

The embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling with the sprit and scope of this disclosure.

While the patent has been described with reference to various embodiments, it will be understood that these embodiments are illustrative and that the scope of the disclosure is not limited to them. Many variations, modifications, additions, and improvements are possible. More generally, embodiments in accordance with the patent have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of detecting and predicting a level of importance of an electronic mail message, comprising:
detecting, by a topic detection module, topic information from the electronic mail message;
detecting, by a role detection module, role information of one of a sender and a receiver from the electronic mail message;
detecting, by a relationship detection module, a relationship between the topic information and the role information; and
predicting the level of importance based on the detected topic information, role information, and the relationship.

2. The method of claim 1, wherein at least one of the topic detection module, the role detection module, and the relationship detection module comprise a feature extractor.

3. The method of claim 2, wherein the feature extractor is selected from a group consisting of: N-grams, Part-of-Speech (POS) Tags, Length features, and Content features.

4. The method of claim 3, wherein the feature extractor is located in one or more of the topic detection module, the role detection module, and the relationship detection module.

5. The method of claim 4, wherein one of the topic detection module, the role detection module, and the relationship detection module is included in a non-transitory machine accessible medium that when accessed by a machine, causes the machine to perform operations.

6. A non-transitory machine accessible medium comprising:
detecting topic information from an electronic mail message;
detecting role information of one of a sender and a receiver from the electronic mail message;
detecting a relationship between the topic information and the role information; and
predicting a level of importance based on the topic information, the role information, and the relationship.

7. The non-transitory machine accessible medium of claim 6, wherein at least one of the topic information, the role, and the relationship is selected from a group consisting of: N-grams, Part-of-Speech (POS) Tags, Length features, and Content features.

8. The non-transitory machine accessible medium of claim 7, wherein at least one of the topic information, the role information, and the relationship is located in one or more of a topic detection module, a role detection module, and a relationship detection module.
